(19) United States
(12) Patent Application Publication
(10) Pub. No.: US 2025/0065507 A1
(43) Pub. Date: Feb. 27, 2025

(54) Robot Control System, Robot, and Robot Control Method

(71) Applicants: Hyundai Motor Company, Seoul (KR); Kia Corporation, Seoul (KR)

(72) Inventors: Jung Min Ryu, Hwaseong-Si (KR); Jin Woo Kim, Seoul (KR); Yun Jae Kim, Seongnam-Si (KR); Seok Won Kim, Hwaseong-Si (KR)

(21) Appl. No.: 18/535,573

(22) Filed: Dec. 11, 2023

(30) Foreign Application Priority Data
Aug. 21, 2023 (KR) 10-2023-0109249

(51) Int. Cl. B25J 9/16

(52) U.S. Cl. CPC B25J 9/1689; B25J 9/1674

(57) ABSTRACT

A system for controlling a robot is provided. The system may comprise a controller configured to communicate with a robot, over a network via a communication device, wherein the controller may comprise a workflow engine and configured to determine a state of the robot and a state of the network, transmit at least one of a command or a scenario to the robot, cause, based on a first state of the robot, the robot to receive a task group from the controller, and perform an operation associated with the command, wherein the command is associated with at least one task of the task group, and cause, based on a second state of the robot, the robot to receive the scenario from the controller, apply, to another workflow engine, the scenario to obtain a plurality of tasks, and perform an operation associated with the plurality of tasks.

### CROSS-REFERENCE TO RELATED APPLICATION

This application claims the benefit of priority to Korean Patent Application No. 10-2023-0109249, filed in the Korean Intellectual Property Office on Aug. 21, 2023, the entire contents of which are incorporated herein by reference.

### TECHNICAL FIELD

The present disclosure relates to a robot control system, a robot, and a robot control and more particularly, relates to technologies for allowing a control cloud and a robot to interwork with each other.

### BACKGROUND

As signal intensity may not reach an autonomous driving-based service robot depending on a wireless network infrastructure situation, the service robot may be in an offline state. As a way to cope with the offline state, various coverage scenarios may be applicable depending on a service type of the robot.

For example, a delivery service robot may use a 5th generation (5G) or long term evolution (LTE) network provided by an Internet service provider (ISP). In a situation in which there is a partial shadow area such as the inside of an elevator, the delivery service robot may be able to perform delivery to a destination in an offline state. Furthermore, a patrol robot of a smart factory may apply an offline scenario to wait in a stop state or move to a safe place to avoid a collision with another driving robot in an offline situation.

A robot control system may perform an operation offline, because an external control cloud manages a scenario engine of a robot, or it is difficult to identify or control a state in real time, because the scenario engine of the robot is embedded in the robot.

Therefore, to address such problems, there is a need to develop a technology for loading a workflow engine into a control cloud and a robot and allowing the control cloud and the robot to interwork with each other.

### SUMMARY

According to the present disclosure, a system may comprise: a communication device, and a controller configured to communicate with a robot, comprising a first workflow engine, over a network via the communication device, wherein the controller may comprise a second workflow engine and further configured to: determine a state of the robot and a state of the network, transmit at least one of a command or a scenario to the robot, cause, based on the state of the robot being in a first state, the robot to: receive a task group from the controller, and perform an operation associated with the command, wherein the command is associated with at least one task of the task group, and cause, based on the state of the robot being a second state, the robot to: receive the scenario from the controller, apply, to the first workflow engine, the scenario to obtain a plurality of tasks, and perform an operation associated with the plurality of tasks.

The system, wherein the controller is configured to: apply a first scenario to the second workflow engine to obtain a first task group based on the state of the robot being the first state, and transmit, to the robot, a command associated with at least one task of the first task group.

The system, wherein the controller is configured to: generate, based on the state of the network, a first exceptional scenario different from the first scenario, apply the first exceptional scenario to the second workflow engine to obtain a first exceptional task group, transmit, to the robot, a command associated with at least one task of the first exceptional task group, and monitor the state of the robot during performance of the command associated with the at least one task of the first exceptional task group.

The system, wherein the controller is configured to: generate a representative scenario may comprise a second scenario and a second exceptional scenario based on the state of the robot being the second state, and transmit, to the robot, the representative scenario.

The system, wherein the controller is configured to cause the robot to: apply the second scenario in the representative scenario received from the controller to the first workflow engine to obtain a second task group, and apply the second exceptional scenario to the first workflow engine to obtain a second exceptional task group based on: an occurrence of an exceptional situation associated with the second exceptional scenario and an operation associated with at least one task of the second task group.

The system, wherein the controller is configured to cause the robot to transmit, to the controller, results of performing the at least one task of the second task group and at least one task of the second exceptional task group based on performing: the operation associated with the at least one task of the second task group, and an operation associated with the at least one task of the second exceptional task group.

The system, wherein the controller is configured to: apply a third scenario to the second workflow engine to obtain a third task group based on the state of the robot being a third state different from the first state and the second state, and transmit, to the robot and through a first channel of the controller, at least one task of the third task group.

The system, wherein the controller is configured to cause the robot to: perform an operation associated with at least one task of the third task group, wherein the at least one task of the third task group is received, from the controller, in the third state, and transmit, to a second channel of the controller, the state of the robot and the state of the network.

The system, wherein the controller is configured to: determine whether the state of the robot is an exceptional state based on the state of the robot and the state of the network, wherein the state of the robot and the state of the network are received from the robot, transmit, to the robot through the first channel, an operation stop command based on the state of the robot being the exceptional state, and apply a third exceptional scenario to the second workflow engine to obtain a third exceptional task group. The system, wherein the first state may comprise a state in which a connection state of the network between the robot and the controller is established, and wherein the second state may comprise a state in which the connection state of the network between the robot and the controller is not established.

According to the present disclosure, a robot may comprise: a communication device configured to communicate with a control system, a workflow engine configured to obtain a task group, at least one processor, and a memory storing instructions that, when executed by the at least one processor, cause the robot to: in a first state of the robot: receive, via the communication device, a first task group from the control system, and perform an operation associated with a command, wherein the command is associated with at least one task of the first task group, and in a second state of the robot: receive, via the communication device, a scenario from the control system, apply, to the workflow engine, the scenario to obtain a second task group, and perform an operation associated with at least one task of the second task group, and in a third state of the robot: receive, via the communication device, a third task group from the control system, and perform an operation associated with at least one task of the third task group.

The robot, wherein the instructions, when executed by the at least one processor, cause the robot to: apply a second scenario in the scenario received from the control system to the workflow engine to obtain the second task group, in the second state of the robot, and apply a second exceptional scenario in the scenario to the workflow engine to obtain a second exceptional task group based on: an occurrence of an exceptional situation, and an operation associated with at least one task of the second task group.

The robot, wherein the instructions, when executed by the at least one processor, cause the robot to: transmit, to the control system, results of performing the at least one task of the second task group and at least one task of the second exceptional task group based on: the operation associated with the at least one task of the second task group, and an operation associated with the at least one task of the second exceptional task group.

The robot, wherein the instructions, when executed by the at least one processor, cause the robot to transmit, to the control system, a state of the robot and a state of a network. The robot, wherein the first state may comprise a state in which a connection state of a network between the robot and the control system is established, and wherein the second state may comprise a state in which the connection state of the network between the robot and the control system is not established.

According to the present disclosure, a method performed by a control system, the method may comprise: determining a state of a robot and a state of a network at different times, transmitting at least one of a command or a scenario to the robot, based on the state of the robot being a first state at one time: sending, to the robot, a task group, and causing the robot to perform an operation associated with the command, wherein the command is associated with at least one task of the task group, based on the state of the robot being a second state at another time: sending, to the robot, the scenario, causing the robot to apply the scenario to a work flow engine of the robot to obtain a plurality of tasks, and causing the robot to perform an operation associated with the plurality of tasks.

The method, may further comprise: applying a first scenario to a second workflow engine of the control system to obtain a first task group based on the state of the robot being the first state, transmitting, to the robot, a command associated with at least one task of the first task group, generating, based on the state of the network, a first exceptional scenario different from the first scenario, applying the first exceptional scenario to the second workflow engine to obtain a first exceptional task group, transmitting, to the robot, a command associated with at least one task of the first exceptional task group, and monitoring the state of the robot during performance of the command associated with the at least one task of the first exceptional task group.

The method, may further comprise: generating a representative scenario may comprise a second scenario and a second exceptional scenario based on the state of the robot being the second transmitting, to the robot, the state, representative scenario, causing application of the second scenario in the representative scenario sent by the control system to a first workflow engine to obtain a second task group, causing application of the second exceptional scenario to the first workflow engine to obtain a second exceptional task group based on: an occurrence of an exceptional situation associated with the second exceptional scenario and an operation associated with at least one task of the second task group, and receiving results of performing the at least one task of the second task group and at least one task of the second exceptional task group based on: the operation associated with the at least one task of the second task group, and an operation associated with the at least one task of the second exceptional task group.

The method, may further comprise: applying a third scenario to a second workflow engine of the control system to obtain a third task group based on the state of the robot being a third state different from the first state and the second state, transmitting, to the robot via a first channel of the control system, at least one task of the third task group, causing an operation associated with the at least one task of the third task group, the at least one task of the third task group being sent, by the control system, in the third state, and receiving, via a second channel of the control system, the state of the robot and the state of the network.

The method, may further comprise: determining whether the state of the robot is an exceptional state based on the state of the robot and the state of the network, wherein the state of the robot and the state of the network are received from the robot, transmitting an operation stop command to the robot through the first channel based on the state of the robot being the exceptional state, and applying a third exceptional scenario to the second workflow engine to obtain a third exceptional task group.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of a robot control system according to an example of the present disclosure;

FIG. 2 shows an example of a robot control method according to an example of the present disclosure;

FIG. 3 shows an example of a control cloud and a robot, in a robot control system according to an example of the present disclosure;

FIG. 4 shows an example of a method for controlling a robot in a first state, in a robot control system according to an example of the present disclosure;

FIG. 5 shows an example of a method for controlling a robot in a second state, in a robot control system according to an example of the present disclosure;

FIG. 6 shows an example of a method for controlling a robot in a third state, in a robot control system according to an example of the present disclosure;

FIGS. 7A, 7B, and 7C show examples of a method for replacing a task in a third state, in a robot control system according to an example of the present disclosure;

FIG. 8 shows an example of a method for processing a task, in a robot control system according to an example of the present disclosure; and

FIG. 9 shows an example of a computing system associated with a robot control system or a robot control method according to an example of the present disclosure.

With regard to description of drawings, the same or similar denotations may be used for the same or similar components.

### DETAILED DESCRIPTION

Hereinafter, some examples of the present disclosure will be described in detail with reference to the exemplary drawings. In the drawings, the same reference numerals will be used throughout to designate the same or equivalent components. In addition, a detailed description of well-known features or functions will be ruled out in order not to unnecessarily obscure the gist of the present disclosure. Hereinafter, various examples of the present disclosure may be described with reference to the accompanying drawings. However, it should be understood that this is not intended to limit the present disclosure to specific implementation forms and includes various modifications, equivalents, and/or alternatives of examples of the present disclosure. With regard to description of drawings, similar components may be marked by similar reference numerals.

In describing components of examples of the present disclosure, the terms first, second, A, B, (a), (b), and the like may be used herein. These terms are only used to distinguish one component from another component, but do not limit the corresponding components irrespective of the order or priority of the corresponding components. Furthermore, unless otherwise defined, all terms including technical and scientific terms used herein are to be interpreted as is customary in the art to which this present disclosure belongs. It will be understood that terms used herein should be interpreted as having a meaning that is consistent with their meaning in the context of this present disclosure and the relevant art and will not be interpreted in an idealized or overly formal sense unless expressly so defined herein. For example, the terms, such as “first”, “second”, “1st”, “2nd”, or the like used in the present disclosure may be used to refer to various components regardless of the order and/or the priority and to distinguish one component from another component, but do not limit the components. For example, a first user device and a second user device indicate different user devices, irrespective of the order and/or priority. For example, without departing the scope of the present disclosure, a first component may be referred to as a second component, and similarly, a second component may be referred to as a first component.

In the present disclosure, the expressions “have”, “may have”, “include” and “comprise”, or “may include” and “may comprise” indicate existence of corresponding features (e.g., components such as numeric values, functions, operations, or parts), but do not exclude presence of additional features.

It will be understood that when a component (e.g., a component) is referred to as being “(operatively or communicatively) coupled with/to” or “connected to” another component (e.g., a second component), it can be directly coupled with/to or connected to the other component or an intervening component (e.g., a third component) may be present. In contrast, when a component (e.g., a first component) is referred to as being “directly coupled with/to” or “directly connected to” another component (e.g., a second component), it should be understood that there is no intervening component (e.g., a third component).

According to the situation, the expression “configured to” used in the present disclosure may be used exchangeably with, for example, the expression “suitable for”, “having the capacity to”, “designed to”, “adapted to”, “made to”, or “capable of”.

The term “configured to” must not mean only “specifically designed to” in hardware. Instead, the expression “a device configured to” may mean that the device is “capable of” operating together with another device or other parts. For example, a “processor configured to perform A, B, and C” may mean a generic-purpose processor (e.g., a central processing unit (CPU) or an application processor) which may perform corresponding operations by executing one or more software programs which store a dedicated processor (e.g., an embedded processor) for performing a corresponding operation or a memory device. The terms of a singular form may include plural forms unless the context clearly indicates otherwise. All the terms used herein, which include technical or scientific terms, may have the same meaning that is generally understood by a person skilled in the art described in the present disclosure. It will be further understood that terms, which are defined in a dictionary and commonly used, should also be interpreted as is customary in the relevant related art and not in an idealized or overly formal detect unless expressly so defined herein in various examples of the present disclosure. In some cases, even though terms are terms which are defined in the specification, they may not be interpreted to exclude examples of the present disclosure.

In the present disclosure, the expressions “A or B”, “at least one of A or/and B”, or “one or more of A or/and B”, and the like may include any and all combinations of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included. Furthermore, in describing an example of the present disclosure, each of such phrases as “A or B”, “at least one of A and B”, “at least one of A or B”, “A, B, or C”, “at least one of A, B, and C”, “at least one of A, B, or C”, and “at least one of A, B, or C, or any combination thereof” may include any one of, or all possible combinations of the items enumerated together in a corresponding one of the phrases. Particularly, the phrase such as “at least one of A, B, or C, or any combination thereof” may include “A”, “B”, or “C”, or “AB” or “ABC”, which is a combination thereof.

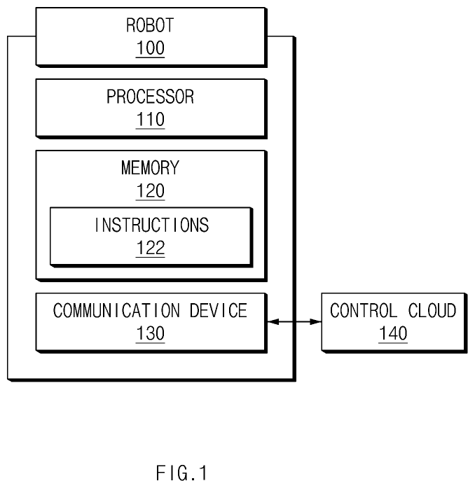

Hereinafter, examples of the present disclosure will be described in detail with reference to FIGS. 1 to 9.

FIG. 1 shows an example of a robot control system according to an example of the present disclosure.

The robot control system according to an example may include a robot 100 and a control cloud 140.

The robot 100 according to an example may include a processor 110, a memory 120 including instructions 122, and a communication device 130. For example, the robot 100 may include a first workflow engine.

For example, a workflow engine (e.g., the first workflow engine and a second workflow engine) may indicate software components which assist in executing automation of a business process. The workflow engine may provide a function for defining and executing a process and may manage and control flow of the process. The workflow engine may receive a scenario as an input and may output a task group about the received scenario.

For example, the scenario may include a plurality of tasks, a branch point between the tasks, a connection between the task and the branch, and an event for processing an exception (e.g., an error, expiration, or the like). Herein, the task may be unit work of the scenario, which may indicate an operation set of a predetermined robot. Furthermore, the robot 100 may perform an operation about the task and may perform a subsequent operation based on information included in the branch point.

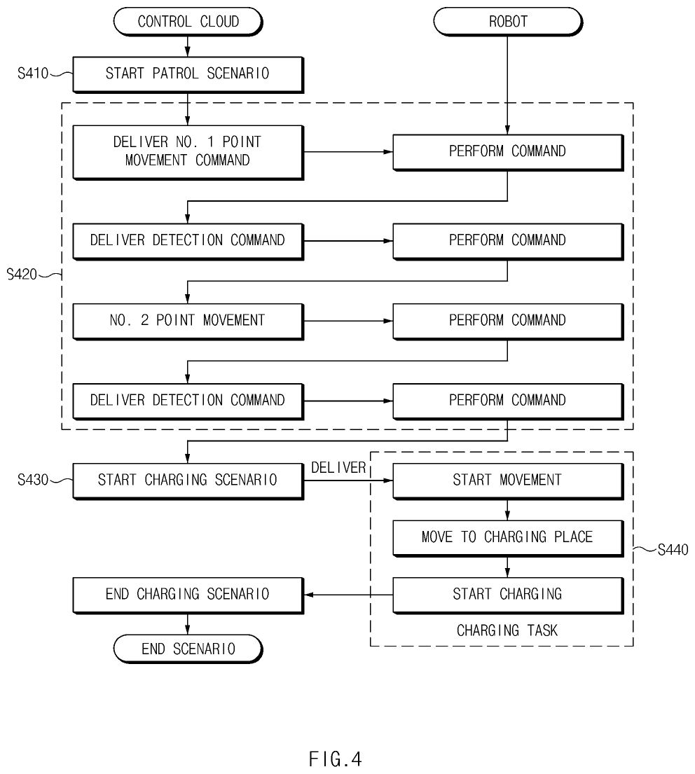

In a first state, the robot 100 may perform an operation about a command of each of at least one task included in the task group, which is received from the control cloud 140. Furthermore, in a second state, the robot 100 may perform an operation about tasks obtained by applying the scenario received from the control cloud 140 to the first workflow engine. In addition, in a third state, the robot 100 may perform an operation about a command of each of at least one task received from the control cloud 140. A detailed method in which the robot 100 performs the operation in each of the first state, the second state, and the third state will be described in detail below with reference to FIGS. 4 to 6.

For example, the first state may include a state in which a connection state of a network between the robot 100 and the control cloud 140 is always ensured online. In other words, the first state may include that an environment in which the robot 100 performs an operation about a command and a task is mainly in an online state. The second state may include a state in which the connection state of the network between the robot 100 and the control cloud 140 is not always ensured online. In other words, the second state may include that the environment in which the robot 100 performs the operation about the command and the task is mainly in an offline state. For example, the third state may include a partially offline state in an exceptional situation, on the assumption that the connection state of the network between the robot 100 and the control cloud 140 is an online state. As the robot 100 performs an operation in each of the first state, the second state, and the third state, a detailed description of the first to third states will be described in detail below with reference to FIGS. 4 to 6.

The processor 110 may execute software and may control at least one other component (e.g., a hardware or software component) connected with the processor 110. In addition, the processor 110 may perform a variety of data processing or calculation. For example, the processor 110 may store, a task, a scenario, and a command in the memory 120.

For reference, r the processor 110 may perform all operations performed by the robot 100. Therefore, for convenience of description in the specification, the operation performed by the robot 100 is mainly described as an operation performed by the processor 110. Furthermore, for convenience of description in the specification, the processor 110 is mainly described as, but not limited to, one processor. For example, the robot 100 may include at least one processor. Each of the at least one processor may perform all operations associated with an operation about a task, a scenario, and a command.

The memory 120 may temporarily and/or permanently store various pieces of data and/or information required to control the robot 100. For example, the memory 120 may store, a task, a scenario, and a command.

The communicate device 130 may assist in performing communication between the robot 100 and the control cloud 140. For example, the communication device 130 may include one or more components for performing communication between the robot 100 and the control cloud 140. For example, the communication device 130 may include a short range wireless communication unit, a microphone, or the like. At this time, a short range communication technology may be, but is not limited to, a wireless LAN (Wi-Fi), Bluetooth, ZigBee, Wi-Fi Direct (WFD), ultra-wideband (UWB), infrared data association (IrDA), Bluetooth low energy (BLE), near field communication (NFC), or the like.

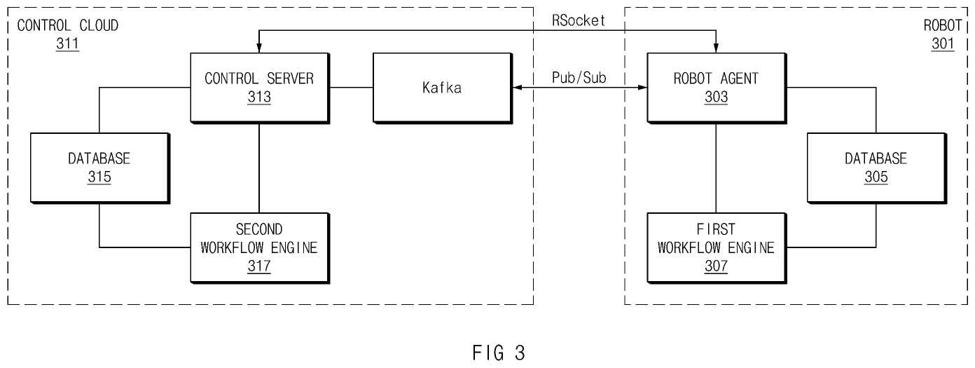

The control cloud 140 may be connected with the robot 100 over a network, may include the second workflow engine, and may indicate a cloud for controlling the robot 100. For example, the control cloud 140 may determine a state of the robot 100 and a state of the network (e.g., a connection between the robot 100 and the control cloud 140) and may transmit at least one of a command or a scenario to the robot 100. A detailed description of the robot 100 and the control cloud 140 included in the robot control system will be described below with reference to FIG. 3.

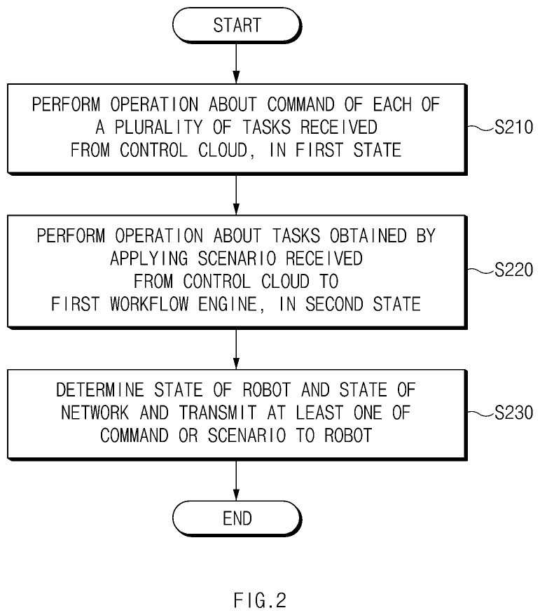

FIG. 2 shows an example of a robot control method according to an example of the present disclosure.

In S210, a robot (e.g., a robot 100 of FIG. 1) may perform an operation about a command of each of a plurality of tasks received from a control cloud (e.g., a control cloud 140 of FIG. 1), in a first state. For example, the robot may perform an operation in a control cloud driving scheme. In other words, the robot may receive only a command of each of the plurality of tasks from the control cloud to perform an operation about the command, in the first state (i.e., a state in which a connection state between the control cloud and a network is ensured online).

The control cloud may determine a state of the robot and may apply a first scenario to a second workflow engine to obtain a first task group, based on the determined result (i.e., the result in which the state of the robot is the first state). The control cloud may transmit a command of each of at least one task included in the obtained first task group to the robot. The robot may receive only the command of each of the at least one task which is the result of the scenario processed by the control cloud, thus performing an operation about the command.

If the state of the robot is the first state, the robot control system may immediately correct a scenario and may reflect the scenario in real time, in the control cloud driving scheme, may perform convenient maintenance for controlling the robot, and may monitor the robot in real time to respond to an unexpected issue (e.g., an exceptional situation).

In S220, the robot may perform an operation about tasks obtained by applying the scenario received from the control cloud to a first workflow engine, in a second state. For example, the robot may perform an operation in a robot driving scheme, in the second state. In other words, the robot may receive the scenario from the control cloud to perform the operation about the tasks, in the second state (i.e., a state in which the connection state between the control cloud and the network is not ensured online).

The control cloud may determine a state of the robot and may apply a second scenario to the robot, based on the determined result (i.e., the result in which the state of the robot is the second state). The robot may apply the received second scenario to the first workflow engine to obtain a second task group. The robot may perform an operation about at least one task included in the obtained second task group.

If the state of the robot is the second state, the robot control system may expand a converge of a robot operation even in an offline environment and an environment in which the network is unstable.

In S230, the control cloud may determine a state of the robot and a state of a network and may transmit at least one of the command or the scenario to the robot. For example, if the state of the robot is the first state, the control cloud may transmit the command to the robot. Furthermore, if the state of the robot is the second state, the control cloud may transmit the scenario to the robot. However, the target and the condition transmitted to the robot by the control cloud are not limited thereto. For example, the control cloud may transmit the scenario to the robot, if the state of the robot is the first state, and may transmit the command to the robot, if the state of the robot is the second state. Therefore, for convenience of description in the specification, it is mainly described that the control cloud may transmit the command to the robot, if the state of the robot is the first state, and may transmit the scenario to the robot, if the state of the robot is the second state.

FIG. 3 shows an example of a control cloud and a robot, in a robot control system according to an example of the present disclosure.

The robot control system according to an example may include a robot 301 and a control cloud 311.

The robot 301 may include a robot agent 303, a database 305, and a first workflow engine 307. The robot agent 303 may apply a command, a task, or a scenario received from the control cloud 311 to the first workflow engine 307 on behalf of the robot 301.

In detail, the robot agent 303 may receive a task or the like through a first channel (e.g., which is shown as RSocket in FIG. 3) from a control server 313 of the control cloud 311.

When receiving the scenario through the first channel from the control server 313, the robot agent 303 may apply the received scenario to the first workflow engine 307 to obtain a task group. The task group may include at least one task associated with the received scenario.

The robot agent 303 may store the obtained task group in the database 305. Furthermore, the robot agent 303 may transmit or receive data of a status in which the scenario is in progress through a second channel (e.g., which is shown as Kafka in FIG. 3) and a publish/subscribe (Pub/Sub) function.

The control cloud 311 may include the control server 313, a database 315, and a second workflow engine 317. For example, similar to the robot agent 303 of the robot 301, the control server 313 may apply a scenario to the second workflow engine 317 on behalf of the control cloud 311.

In detail, the control server 313 may transmit at least one of a scenario (e.g., first to third scenarios), a task group (e.g., first to third task groups), or a command, or any combination thereof to the robot 301 through the first channel.

For reference, the first workflow engine 307 may be a business process model and notation (BPMN)-based workflow engine of the same version as the second workflow engine 317. For example, BPMN may be a standardized graphical notation for modeling and representing a business process. The BPMN may be used to share the business process with various stakeholders and represent the business process to be easily understood. The BPMN may be a notation capable of describing a structure, flow, an interaction of the business process in detail and easily performing communication between the stakeholders. As a result, a robot control system may have the BPMN-based workflow engine of the same version to be identical in the robot 301 and the control cloud 311 and may select driving in a control cloud scheme and driving in a robot driving scheme to respond to a robot service scheme and each exceptional situation, depending on driving settings of a scenario and a task.

FIG. 4 shows an example of a method for controlling a robot in a first state, in a robot control system according to an example of the present disclosure.

The robot control system according to an example may control a robot, based on a robot (e.g., a robot 301 of FIG. 1) and a control cloud (e.g., a control cloud 311 of FIG. 3) in a first state.

For example, the first state may include a state in which the robot operates in an online state, for example, movement of the robot, detection of the robot, or transmission of the detected result, in a factory in which a Wi-Fi or LTE repeater is ensured or an open area (e.g., a park) where there is no separate shadow area (e.g., an offline area). Thus, the robot control system may configure a scenario which does not need to drive a separate workflow engine in the robot in the first state.

For example, in S410, the control cloud may start a first scenario (e.g., a patrol scenario in FIG. 4). To this end, in S420, if determining that the state of the robot is the first state, the control cloud may apply the first scenario (e.g., the patrol scenario in the first state) to a second workflow to obtain a first task group of the patrol scenario. The control cloud may transmit a command of each of at least one task included in the first task group of the patrol scenario to the robot. In detail, the first task group of the patrol scenario may include a No. 1 point movement task, a detection task, a No. 2 point movement task, and a detection task.

The control cloud may apply the first scenario (e.g., the patrol scenario in the first state) to the second workflow, may deliver a command, and may control the robot to perform the command. Furthermore, the control cloud may change a task unit in real time if the network environment is good and may monitor a situation for performing a scenario of the robot in real time.

If the robot performs all the operations about the previous first scenario (e.g., the patrol scenario in the first state), in S430, the control cloud may start a subsequent first scenario (e.g., a charging scenario in the first state). To this end, if determining that the state of the robot is the first state, the control cloud may directly transmit the subsequent first scenario (e.g., the charging scenario in the first state) to the robot.

In S440, the robot may apply the subsequent first scenario (e.g., the charging scenario in the first state) to the first workflow engine to obtain a first task group of the charging scenario. In detail, the first task group of the charging scenario may include a movement start task, a charging place movement task, and a charging start task.

For reference, for convenience of description in the specification, the first scenario and the first task group are described as targets transmitted/received between the robot and the control cloud if the state of the robot is the first state. In detail, if the state of the robot is the first state, the first scenario may include the patrol scenario and the charging scenario. In addition, the first task group may include a task group of the patrol scenario and a task group of the charging scenario. Therefore, the first scenario and the first task group are not limited thereto.

The control cloud may monitor the robot in real time to respond to an immediate issue. For example, the control cloud may generate a first exceptional scenario different from the first scenario, based on a state of a network. In other words, the first exceptional scenario may include at least one task for overcoming an exceptional situation of the first scenario. The control cloud may apply the first exceptional scenario to the second workflow engine to obtain a first exceptional task group. The control cloud may transmit a command of each of at least one task included in the first exceptional task group. The control cloud may monitor a state of the robot which performs the command of each of the at least one task included in the first exceptional task group.

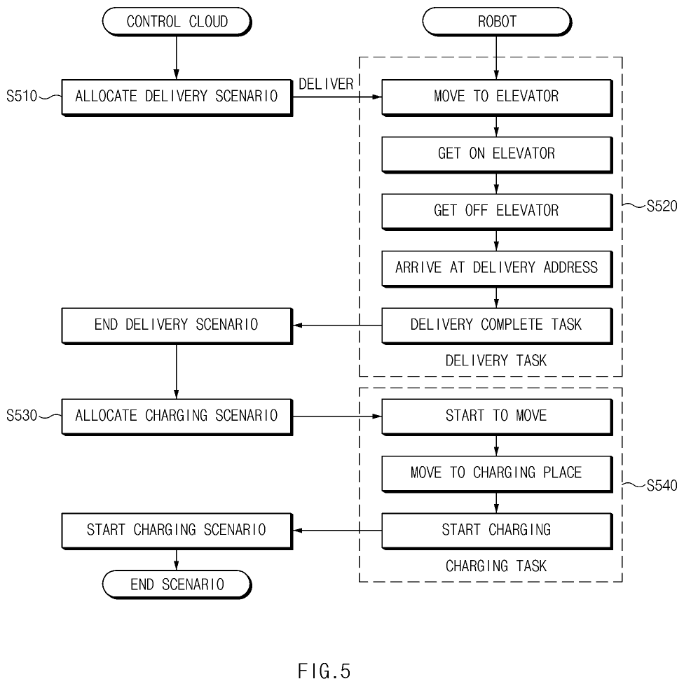

FIG. 5 shows an example of a method for controlling a robot in a second state, in a robot control system according to an example of the present disclosure.

The robot control system according to an example may control a robot, based on a robot (e.g., a robot 301 of FIG. 3) and a control cloud (e.g., a control cloud 311 of FIG. 3) in second first state.

For example, the second state may include getting on and off the elevator and entering and exiting the front door, for example, an environment in which an indoor and outdoor delivery robot service is performed, a case in which there is a limitation in a network bandwidth or the like, for example, getting on and off the elevator, moving the robot to the basement, and a case in which there are many users who uses the same network, and an unstable or frequently offline situation. Thus, the robot control system may configure a scenario to have a task in a robot local environment such that interworking between the robot and the control cloud is not required in the second state.

For example, in S510, the control cloud may start a second scenario (e.g., a delivery scenario in FIG. 5). If determining that the state of the robot is the second state, the control cloud may generate a representative scenario including the second scenario (e.g., the delivery scenario in the second state) and a second exceptional scenario. The control cloud may transmit the representative scenario to the robot in, for example, for each XML.

Herein, the second exceptional scenario may include at least one task for overcoming an exceptional situation of the second scenario, if a predetermined exception occurs or if communication between the robot and the control cloud is not performed.

The robot may apply the second scenario (e.g., the delivery scenario in the second state) in the representative scenario received from the control cloud to a first workflow engine to obtain a second task group of the delivery scenario. If an exceptional situation associated with the second exceptional scenario occurs, while performing an operation about at least one task included in the second task group, the robot may apply the second exceptional scenario to the first workflow engine to obtain a second exceptional task group.

For example, the above-mentioned exceptional situation may include a situation in which the network is offline after the robot gets on and off the elevator. In this case, the second exceptional scenario may include a TTS speech output task (e.g., a getting-off information output task at the 3rd floor or an information output task for stepping aside for a moment), a robot direction change task for getting-off, and the like.

If the robot performs all the operations about the previous second scenario (e.g., the delivery scenario in the second state), in S530, the control cloud may start a subsequent second scenario (e.g., a charging scenario in the second state). To this end, if determining that the state of the robot is the second state, the control cloud may directly transmit the subsequent second scenario (e.g., the charging scenario in the second state) to the robot.

In S540, the robot may apply the subsequent second scenario (e.g., the charging scenario in the second state) to the first workflow engine to obtain a second task group of the charging scenario.

For reference, for convenience of description in the specification, the second scenario and the second task group are described as targets transmitted/received between the robot and the control cloud if the state of the robot is the second state. In detail, if the state of the robot is the second state, the second scenario may include the delivery scenario and the charging scenario. In addition, the second task group may include a task group of the delivery scenario and a task group of the charging scenario. Therefore, the second scenario and the second task group are not limited thereto.

When performing an operation about at least one task included in the second task group (e.g., the second task group of the delivery scenario or the second task group of the charging scenario) and an operation about at least one task included in the second exceptional task group, the robot may transmit the result of performing the at least one task included in the second task group and performing the at least one task included in the second exceptional task group to the control server.

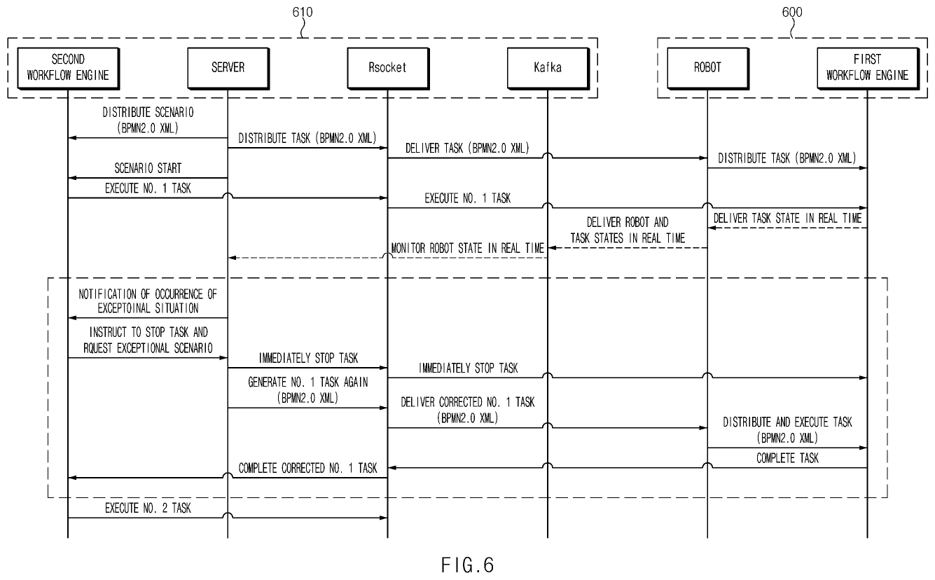

FIG. 6 shows an example of a method for controlling a robot in a third state, in a robot control system according to an example of the present disclosure.

The robot control system according to an example may control a robot, based on a robot 600 and a control cloud 610 in the third state.

For example, the third state is a partially offline state in an exceptional situation, on the assumption that the connection state of a network between the robot 600 and the control cloud 610 is an online state. In the third state of the robot 600, the robot control system needs to reflect and drive an exceptional scenario except for a previously prepared scenario in real time using a workflow engine for an unexpected situation. In detail, if the state of one robot is the third state (e.g., if the one robot is in an offline state by a collision accident due to incorrect priorities when performing cross driving with another robot), the robot control system may simultaneously reflect a scenario (e.g., a third exceptional scenario) in which the priorities are adjusted in all robots which are already operating in real time.

If determining that the state of the robot 600 is the third state different from each of the first stat and the second state, the control cloud 610 may apply a third scenario to a second workflow engine to obtain a third task group. For example, a control server of the control cloud 610 may apply the third scenario to the second workflow engine to distribute a scenario for each BPMN 2.0 XML. The control server may transmit at least one task included in the third task group obtained by applying the third scenario to the second workflow engine to the robot 600 through a first channel (e.g., RSocket).

In the third state, the robot 600 may perform an operation about the at least one task included in the third task group, which is received from the control cloud 610, and/or a command of each of the at least one task included in the third task group. For example, when receiving the third scenario from the control cloud 610, the robot 600 may apply the received third scenario to a first workflow engine to obtain the third task group. When receiving the third task group from the control cloud 610, the robot 600 may perform an operation about at least one task included in the received third task group. When receiving the command of each of the at least one task included in the third task group from the control cloud 610, the robot 600 may perform an operation about the command.

The robot 600 may transmit a state of the robot and a state of the network through a second channel (e.g., Kafka) included in the control cloud 610.

The control cloud 610 may determine whether the state of the robot is an exceptional state, based on the state of the robot and the state of the network, which are received from the robot 600. If the state of the robot is the exceptional state, the control cloud 610 may transmit an operation stop command to the robot 600 through a first channel. Furthermore, to address the exceptional state, the control cloud 610 may apply a third exceptional scenario to the second workflow engine to obtain a third exceptional task group.

In the third state, the robot 600 may perform an operation about at least one task included in the third exceptional task group received from the control cloud 610 and/or a command of each of the at least one task included in the third exceptional task group.

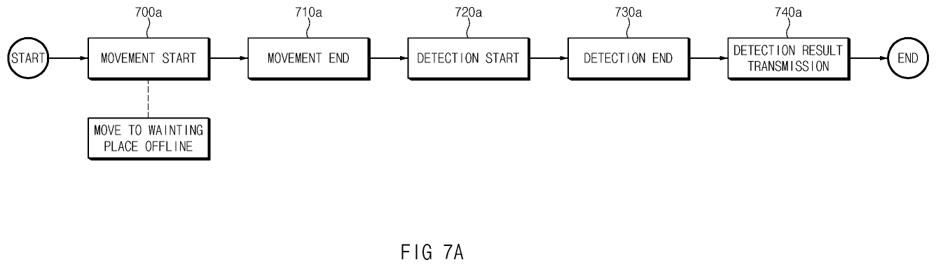

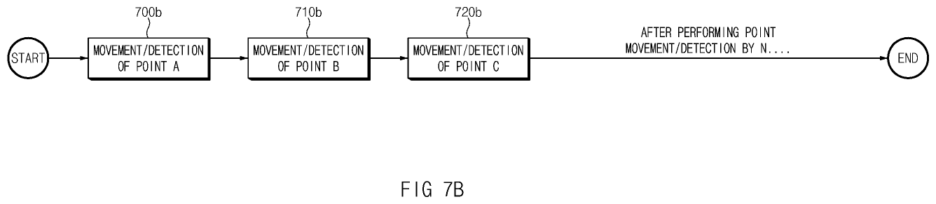

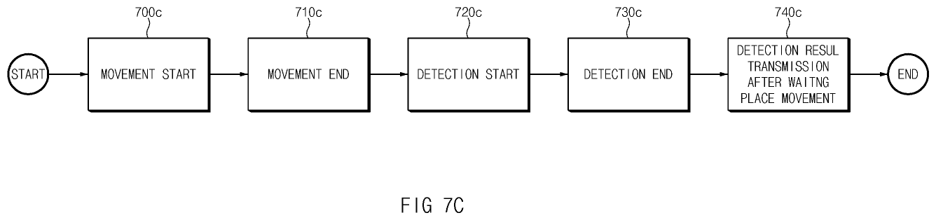

FIGS. 7A to 7C show examples of a method for replacing a task in a third state, in a robot control system according to an example of the present disclosure.

FIG. 7A shows an example of a process of performing an operation about a movement task and a detection task in a third state in a robot (e.g., a robot 301 of FIG. 3). For example, the robot may perform an operation of a task for movement start 700a and movement end 710a, in conjunction with the movement task. Thereafter, the robot may perform an operation of a task for detection start 720a and detection end 730a, in conjunction with the detection task. The robot may transmit the result of performing the operation about the movement task and the detection task to a control cloud (e.g., a control cloud 311 of FIG. 3) using an operation of a task for detection result transmission 740a.

FIG. 7B shows an example of a process of performing an operation about a plurality of third scenarios, each of which includes a movement task and a detection task, in a third state in a robot. For example, the robot may perform an operation about a third scenario 700b of movement of point A and detection of point A, at point A. The robot may apply the third scenario 700b of the movement of point A and the detection of point A to a first workflow engine to obtain a third task group of the third scenario 700b of the movement of point A and the detection of point A. Similarly, the robot may perform each of operations about a third scenario 710b of movement of point B and detection of point B and a third scenario 720b of movement of point C and detection of point C.

FIG. 7C shows an example of a process of performing an operation in a third exceptional scenario rather than the third scenario, if the robot is in an exceptional state due to offline occurrence at least one of point A, point B, or point C of FIG. 7B. For example, if the robot is in the exceptional state due to the offline occurrence at point B, the control cloud may transmit an operation stop command to the robot. Thereafter, the control cloud may apply the third exceptional scenario to the second workflow engine to obtain a third exceptional task group.

The control cloud may transmit the third exceptional task group to the robot which is in the exceptional state due to the offline occurrence at point B. The robot may perform an operation about at least one task included in the third exceptional task group. For example, reference numerals 700c, 710c, 720c, and 730c in FIG. 7C may be the same as reference numerals 700a to 730a in FIG. 7A, in other words, the at least one task included in the third exceptional task group may be the same as the at least one task included in the third task group. However, unlike the third task group, the third exceptional task group may further include a task for detection result transmission after waiting place movement 740c.

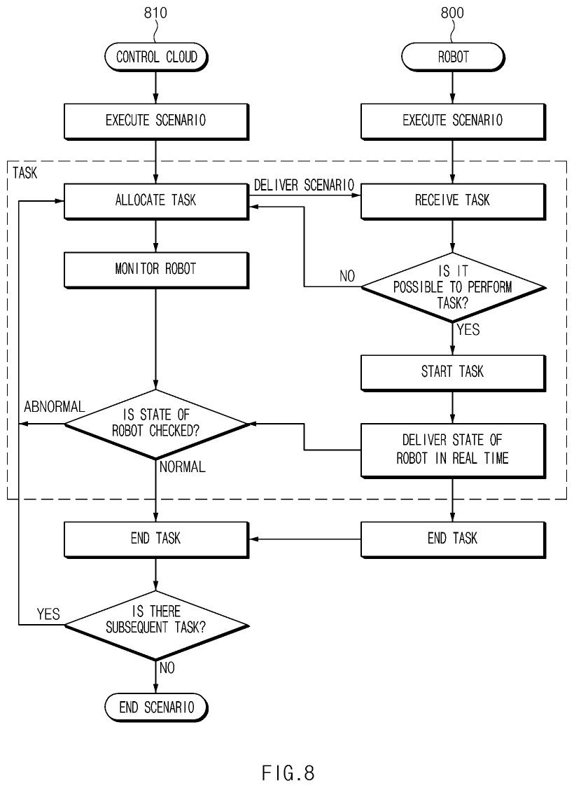

FIG. 8 shows an example of a method for processing a task, in a robot control system according to an example of the present disclosure.

FIG. 8 shows an example of a method for processing a scenario and a task in a robot control system.

A robot 800 may be in a task waiting state before receiving at least one of a command, a task group, or a scenario from a control cloud 810.

The control cloud 810 may execute the scenario. For example, the control cloud 810 may transmit the scenario to the robot 800. Furthermore, the control cloud 810 may apply the scenario to a workflow engine to obtain a task group and may transmit the obtained task group to the robot 800. In addition, the control cloud 810 may transmit a command of each of at least one task included in the task group to the robot 800. In other words, the control cloud 810 may transmit at least one of the command, the task group, or the scenario to the robot 800 to execute the scenario.

The robot 800 may determine whether it is possible to perform the task received from the control cloud 810. If the robot 800 is able to perform an operation about the received task, it may transmit start of the task and a state of the robot 800 to the control cloud 810 in real time. Otherwise, if the robot 800 is unable to perform the operation about the received task, it may transmit performance impossibility information to the control cloud 810.

For reference, whether the robot 800 is able to perform the operation about the received task may include at least one of a battery state, a command which is unable to be identified by the control cloud 810, or a case in which there is an obstacle around the robot 800.

The control cloud 810 may transmit, for example, a task to the robot 800 and may monitor the robot 800 in real time, thus checking a state of the robot 800. Thereafter, when receiving information of task end from the robot 800, the control cloud 810 may identify whether there is a subsequent task and may end the scenario.

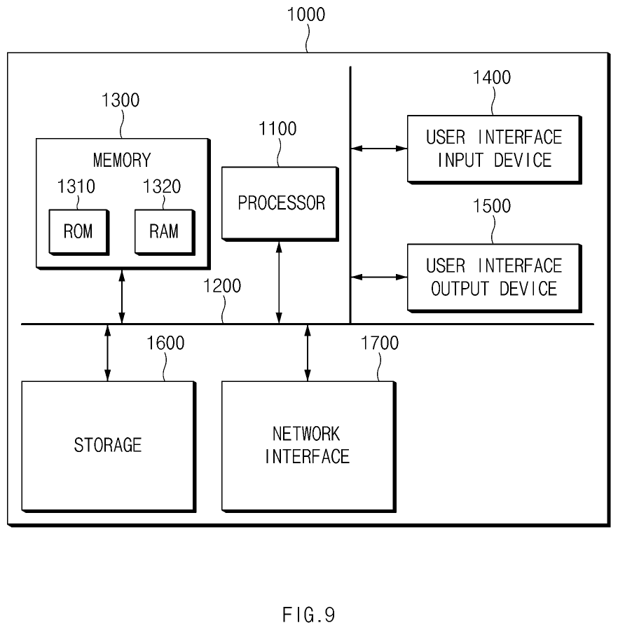

FIG. 9 shows an example of a computing system associated with a robot control system or a robot control method according to an example of the present disclosure.

Referring to FIG. 9, a computing system 1000 about the robot control system or the robot control method may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Accordingly, the operations of the method or algorithm described in connection with the examples disclosed in the specification may be directly implemented with a hardware module, a software module, or a combination of the hardware module and the software module, which is executed by the processor 1100. The software module may reside on a storage medium (that is, the memory 1300 and/or the storage 1600) such as a RAM, a flash memory, a ROM, an EPROM, an EEPROM, a register, a hard disc, a removable disk, and a CD-ROM.

The present disclosure has been made to solve the above-mentioned problems occurring in the prior art while advantages achieved by the prior art are maintained intact.

An example of the present disclosure provides a robot control system for simultaneously loading a workflow engine into a control cloud and a robot to minimize an issue of the control of the robot although a network state between the robot and the control cloud is unstable, a robot, and a robot control method.

Another example of the present disclosure provides a robot control system for performing an operation about a command of each of tasks included in a task group in a first state to change a task instruction in real time although the situation in which the robot performs the operation is an exceptional situation, a robot, and a robot control method.

Another example of the present disclosure provides a robot control system for applying a scenario to a workflow engine to perform an operation about tasks in a second state to reduce the frequency of direct communication between the robot and the control cloud, easily perform control of the robot, and reduce cloud communication cost (or traffic), a robot, and a robot control method.

Another example of the present disclosure provides a robot control system for performing an operation about a command of each of tasks included in a task group in a third state to process a task by only using a change in scenario based on the same control cloud and robot structure, depending on a service type (e.g., a delivery service or a patrol service) of the robot or an area and/or an environment in which the robot performs the operation (e.g., the service) to reduce development cost, a robot, and a robot control method.

The technical problems to be solved by the present disclosure are not limited to the aforementioned problems, and any other technical problems not mentioned herein will be clearly understood from the following description by those skilled in the art to which the present disclosure pertains.

According to an example of the present disclosure, a robot control system may include a robot including a first workflow engine and a control cloud that is connected with the robot over a network and includes a second workflow engine to control the robot. The robot may perform an operation about a command of each of at least one task included in a task group received from the control cloud, in a first state and may perform an operation about tasks obtained by applying a scenario received from the control cloud to the first workflow engine, in a second state. The control cloud may determine a state of the robot and a state of the network and may transmit at least one of a command or the scenario to the robot.

In an example, the control cloud may apply a first scenario to the second workflow engine to obtain a first task group, if determining that the state of the robot is the first state, and may transmit a command of each of at least one task included in the first task group to the robot.

In an example, the control cloud may generate a first exceptional scenario different from the first scenario, based on the state of the network, may apply the first exceptional scenario to the second workflow engine to obtain a first exceptional task group, may transmit a command of each of at least one task included in the first exceptional task group to the robot, and may monitor the state of the robot which performs the command of each of the at least one task included in the first exceptional task group.

In an example, the control cloud may generate a representative scenario including a second scenario and a second exceptional scenario, if determining that the state of the robot is the second state, and may transmit the representative scenario to the robot.

In an example, the robot may apply the second scenario in the representative scenario received from the control cloud to the first workflow engine to obtain a second task group and may apply the second exceptional scenario to the first workflow engine to obtain a second exceptional task group, if an exceptional situation associated with the second exceptional scenario occurs, while performing an operation about at least one task included in the second task group.

In an example, the robot may transmit the result of performing the at least one task included in the second task group and at least one task included in the second exceptional task group to the control cloud, if performing the operation about the at least one task included in the second task group and an operation about the at least one task included in the second exceptional task group.

In an example, the control cloud may apply a third scenario to the second workflow engine to obtain a third task group, if determining that the state of the robot is a third state different from each of the first stat and the second state, and may transmit at least one task included in the third task group to the robot through a first channel included in the control cloud.

In an example, the robot may perform an operation about the at least one task included in the third task group, the at least one task being received from the control cloud, in the third state, and may transmit the state of the robot and the state of the network to a second channel included in the control cloud.

In an example, the control cloud may determine whether the state of the robot is an exceptional state, based on the state of the robot and the state of the network, the states being received from the robot, may transmit an operation stop command to the robot through the first channel, if the state of the robot is the exceptional state, and may apply a third exceptional scenario to the second workflow engine to obtain a third exceptional task group.

In an example, the first state may include a state in which a connection state of the network between the robot and the control cloud is always ensured online, and the second state may include a state in which the connection state of the network between the robot and the control cloud is not always ensured online.

According to another example of the present disclosure, a robot include a memory storing computer-executable instructions, a communication device that communicates with a control cloud, and at least one processor that accesses the memory and executes the instructions. The at least one processor may perform an operation about a command of each of at least one task included in a first task group received from the control cloud, in a first state, may perform an operation about at least one task included in a second task group obtained by applying a scenario received from the control cloud to a workflow engine, in a second state, and may perform an operation about at least one task included in a third task group received from the control cloud, in a third state.

In an example, the at least one processor may apply a second scenario in the scenario received from the control cloud to the workflow engine to obtain a second task group, in the second state and may apply a second exceptional scenario in the scenario to the workflow engine to obtain a second exceptional task group, if an exceptional situation occurs while performing an operation about at least one task included in the second task group.

In an example, the at least one processor may transmit the result of performing the at least one task included in the second task group and at least one task included in the second exceptional task group to the control cloud, if performing the operation about the at least one task included in the second task group and an operation about the at least one task included in the second exceptional task group.

In an example, the at least one processor may transmit a state of the robot and a state of a network of the robot to the control cloud.

In an example, the first state may include a state in which a connection state of a network between the robot and the control cloud is always ensured online, and the second state may include a state in which the connection state of the network between the robot and the control cloud is not always ensured online.

According to another example of the present disclosure, a robot control method may include performing an operation about a command of each of at least one task included in a task group received from a control cloud, in a first state, performing an operation about tasks obtained by applying a scenario received from the control cloud to a first workflow engine, in a second state, and determining a state of a robot and a state of a network and transmitting at least one of a command or the scenario to the robot.

In an example, the robot control method may further include applying a first scenario to a second workflow engine included in the control cloud to obtain a first task group, if it is determined that the state of the robot is the first state, transmitting a command of each of at least one task included in the first task group to the robot, generating a first exceptional scenario different from the first scenario, based on the state of the network, applying the first exceptional scenario to the second workflow engine to obtain a first exceptional task group, transmitting a command of each of at least one task included in the first exceptional task group to the robot, and monitoring the state of the robot which performs the command of each of the at least one task included in the first exceptional task group.

In an example, the robot control method may further include generating a representative scenario including a second scenario and a second exceptional scenario, if it is determined that the state of the robot is the second state, transmitting the representative scenario to the robot, applying the second scenario in the representative scenario received from the control cloud to the first workflow engine to obtain a second task group, applying the second exceptional scenario to the first workflow engine to obtain a second exceptional task group, if an exceptional situation associated with the second exceptional scenario occurs, while performing an operation about at least one task included in the second task group, and transmitting the result of performing the at least one task included in the second task group and at least one task included in the second exceptional task group to the control cloud, if performing the operation about the at least one task included in the second task group and an operation about the at least one task included in the second exceptional task group. In an example, the robot control method may further

include applying a third scenario to a second workflow engine included in the control cloud to obtain a third task group, if it is determined that the state of the robot is a third state different from each of the first stat and the second state, transmitting at least one task included in the third task group to the robot through a first channel included in the control cloud, performing an operation about the at least one task included in the third task group, the at least one task being received from the control cloud, in the third state, and transmitting the state of the robot and the state of the network to a second channel included in the control cloud.

In an example, the robot control method may further include determining whether the state of the robot is an exceptional state, based on the state of the robot and the state of the network, the states being received from the robot, transmitting an operation stop command to the robot through the first channel, if the state of the robot is the exceptional state, and applying a third exceptional scenario to the second workflow engine to obtain a third exceptional task group.

The exemplary storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

Hereinabove, although the present disclosure has been described with reference to examples and the accompanying drawings, the present disclosure is not limited thereto, but may be variously modified and altered by those skilled in the art to which the present disclosure pertains without departing from the spirit and scope of the present disclosure claimed in the following claims.

The above-described examples may be implemented with hardware components, software components, and/or a combination of hardware components and software components. For example, the devices, methods, and components described in the examples may be implemented using general-use computers or special-purpose computers, such as a processor, a controller, an arithmetic logic unit (ALU), a digital signal processor, a microcomputer, a field programmable array (FPGA), programmable logic unit (PLU), a microprocessor, or any device which may execute instructions and respond. A processing unit may perform an operating system (OS) or a software application running on the OS. Further, the processing unit may access, store, manipulate, process and generate data in response to execution of software. It will be understood by those skilled in the art that although a single processing unit may be illustrated for convenience of understanding, the processing unit may include a plurality of processing elements and/or a plurality of types of processing elements. For example, the processing unit may include a plurality of processors or one processor and one controller. Also, the processing unit may have a different processing configuration, such as a parallel processor.

Software may include computer programs, codes, instructions or one or combinations thereof and may configure a processing unit to operate in a desired manner or may independently or collectively instruct the processing unit. Software and/or data may be permanently or temporarily embodied in any type of machine, components, physical equipment, virtual equipment, computer storage media or units or transmitted signal waves so as to be interpreted by the processing unit or to provide instructions or data to the processing unit. Software may be dispersed throughout computer systems connected via networks and may be stored or executed in a dispersion manner. Software and data may be recorded in one computer-readable storage media.

The methods according to examples may be implemented in the form of program instructions which may be executed through various computer means and may be recorded in computer-readable media. The computer-readable media may include program instructions, data files, data structures, and the like alone or in combination, and the program instructions recorded on the media may be specially designed and configured for an example or may be known and usable to those skilled in the art of computer software. Examples of computer-readable media include magnetic media such as hard disks, floppy disks, and magnetic tape; optical media such as compact disc-read only memory (CD-ROM) disks and digital versatile discs (DVDs); magneto-optical media such as floptical disks; and hardware devices that are specially configured to store and perform program instructions, such as read-only memory (ROM), random access memory (RAM), flash memory, and the like. Program instructions include both machine codes, such as produced by a compiler, and higher level codes that may be executed by the computer using an interpreter.

The above-described hardware devices may be configured to act as one or a plurality of software modules to perform the operations of the examples, or vice versa.

Even though the examples are described with reference to restricted drawings, it may be obviously to one skilled in the art that the examples are variously changed or modified based on the above description. For example, adequate effects may be achieved even if the foregoing processes and methods are carried out in different order than described above, and/or the aforementioned components, such as systems, structures, devices, or circuits, are combined or coupled in different forms and modes than as described above or be substituted or switched with other components or equivalents.

A description will be given of effects of the robot control system, the robot, the robot control method according to an example of the present disclosure.

According to at least one of examples of the present disclosure, the robot control system may simultaneously load a workflow engine into a control cloud and a robot, thus minimizing an issue of the control of the robot although a network state between the robot and the control cloud is unstable.

Furthermore, according to at least one of examples of the present disclosure, the robot control system may perform an operation about a command of each of tasks included in a task group in a first state, thus changing a task instruction in real time although the situation in which the robot performs the operation is an exceptional situation.

Furthermore, according to at least one of examples of the present disclosure, the robot control system may apply a scenario to a workflow engine to perform an operation about tasks in a second state, thus reducing the frequency of direct communication between the robot and the control cloud, easily performing control of the robot, and reducing cloud communication cost (or traffic).

Furthermore, according to at least one of examples of the present disclosure, the robot control system may perform an operation about a command of each of tasks included in the task group in a third state to process a task by only using a change in scenario based on the same control cloud and robot structure, depending on a service type (e.g., a delivery service or a patrol service) of the robot or an area and/or an environment in which the robot performs the operation (e.g., the service), thus reducing development cost.

In addition, various effects ascertained directly or indirectly through the present disclosure may be provided.

Therefore, other implements, other examples, and equivalents to claims are within the scope of the following claims.

Therefore, examples of the present disclosure are not intended to limit the technical spirit of the present disclosure, but provided only for the illustrative purpose. The scope of the present disclosure should be construed on the basis of the accompanying claims, and all the technical ideas within the scope equivalent to the claims should be included in the scope of the present disclosure.

What is claimed is:

1. A system comprising:
a communication device; and
a controller configured to communicate with a robot, comprising a first workflow engine, over a network via the communication device, wherein the controller comprises a second workflow engine and further configured to:
determine a state of the robot and a state of the network;
transmit at least one of a command or a scenario to the robot;
cause, based on the state of the robot being in a first state, the robot to:
receive a task group from the controller; and
perform an operation associated with the command, wherein the command is associated with at least one task of the task group; and
cause, based on the state of the robot being a second state, the robot to:
receive the scenario from the controller;
apply, to the first workflow engine, the scenario to obtain a plurality of tasks; and
perform an operation associated with the plurality of tasks.

2. The system of claim 1, wherein the controller is configured to:
apply a first scenario to the second workflow engine to obtain a first task group based on the state of the robot being the first state; and
transmit, to the robot, a command associated with at least one task of the first task group.

3. The system of claim 2, wherein the controller is configured to:
generate, based on the state of the network, a first exceptional scenario different from the first scenario;
apply the first exceptional scenario to the second workflow engine to obtain a first exceptional task group;
transmit, to the robot, a command associated with at least one task of the first exceptional task group; and
monitor the state of the robot during performance of the command associated with the at least one task of the first exceptional task group.

4. The system of claim 1, wherein the controller is configured to:
generate a representative scenario comprising a second scenario and a second exceptional scenario based on the state of the robot being the second state; and
transmit, to the robot, the representative scenario.

5. The system of claim 4, wherein the controller is configured to cause the robot to:
apply the second scenario in the representative scenario received from the controller to the first workflow engine to obtain a second task group; and
apply the second exceptional scenario to the first workflow engine to obtain a second exceptional task group based on:
an occurrence of an exceptional situation associated with the second exceptional scenario and
an operation associated with at least one task of the second task group.

6. The system of claim 5, wherein the controller is configured to cause the robot to transmit, to the controller, results of performing the at least one task of the second task group and at least one task of the second exceptional task group based on performing:
the operation associated with the at least one task of the second task group; and
an operation associated with the at least one task of the second exceptional task group.

7. The system of claim 1, wherein the controller is configured to:
apply a third scenario to the second workflow engine to obtain a third task group based on the state of the robot being a third state different from the first state and the second state; and
transmit, to the robot and through a first channel of the controller, at least one task of the third task group.

8. The system of claim 7, wherein the controller is configured to cause the robot to:
perform an operation associated with at least one task of the third task group, wherein the at least one task of the third task group is received, from the controller, in the third state; and
transmit, to a second channel of the controller, the state of the robot and the state of the network.

9. The system of claim 8, wherein the controller is configured to:
determine whether the state of the robot is an exceptional state based on the state of the robot and the state of the network, wherein the state of the robot and the state of the network are received from the robot,
transmit, to the robot through the first channel, an operation stop command based on the state of the robot being the exceptional state; and
apply a third exceptional scenario to the second workflow engine to obtain a third exceptional task group.

10. The system of claim 1, wherein the first state comprises a state in which a connection state of the network between the robot and the controller is established, and
wherein the second state comprises a state in which the connection state of the network between the robot and the controller is not established.

11. A robot comprising:
a communication device configured to communicate with a control system;
a workflow engine configured to obtain a task group;
at least one processor; and
a memory storing instructions that, when executed by the at least one processor, cause the robot to:
in a first state of the robot:
receive, via the communication device, a first task group from the control system; and
perform an operation associated with a command, wherein the command is associated with at least one task of the first task group; and
in a second state of the robot:
receive, via the communication device, a scenario from the control system;
apply, to the workflow engine, the scenario to obtain a second task group; and
perform an operation associated with at least one task of the second task group; and
in a third state of the robot:
receive, via the communication device, a third task group from the control system; and
perform an operation associated with at least one task of the third task group.

12. The robot of claim 11, wherein the instructions, when executed by the at least one processor, cause the robot to:
apply a second scenario in the scenario received from the control system to the workflow engine to obtain the second task group, in the second state of the robot; and
apply a second exceptional scenario in the scenario to the workflow engine to obtain a second exceptional task group based on:
an occurrence of an exceptional situation; and
an operation associated with at least one task of the second task group.

13. The robot of claim 12, wherein the instructions, when executed by the at least one processor, cause the robot to:
transmit, to the control system, results of performing the at least one task of the second task group and at least one task of the second exceptional task group based on:
the operation associated with the at least one task of the second task group; and
an operation associated with the at least one task of the second exceptional task group.

14. The robot of claim 11, wherein the instructions, when executed by the at least one processor, cause the robot to transmit, to the control system, a state of the robot and a state of a network.

15. The robot of claim 11, wherein the first state comprises a state in which a connection state of a network between the robot and the control system is established, and
wherein the second state comprises a state in which the connection state of the network between the robot and the control system is not established.

16. A method performed by a control system, the method comprising:
determining a state of a robot and a state of a network at different times;
transmitting at least one of a command or a scenario to the robot;
based on the state of the robot being a first state at one time:
sending, to the robot, a task group; and
causing the robot to perform an operation associated with the command, wherein the command is associated with at least one task of the task group;
based on the state of the robot being a second state at another time:
sending, to the robot, the scenario;
causing the robot to apply the scenario to a work flow engine of the robot to obtain a plurality of tasks; and
causing the robot to perform an operation associated with the plurality of tasks.

17. The method of claim 16, further comprising:
applying a first scenario to a second workflow engine of the control system to obtain a first task group based on the state of the robot being the first state;
transmitting, to the robot, a command associated with at least one task of the first task group;
generating, based on the state of the network, a first exceptional scenario different from the first scenario;
applying the first exceptional scenario to the second workflow engine to obtain a first exceptional task group;
transmitting, to the robot, a command associated with at least one task of the first exceptional task group; and
monitoring the state of the robot during performance of the command associated with the at least one task of the first exceptional task group.

18. The method of claim 16, further comprising:
generating a representative scenario comprising a second scenario and a second exceptional scenario based on the state of the robot being the second state;
transmitting, to the robot, the representative scenario;
causing application of the second scenario in the representative scenario sent by the control system to a first workflow engine to obtain a second task group;
causing application of the second exceptional scenario to the first workflow engine to obtain a second exceptional task group based on:
an occurrence of an exceptional situation associated with the second exceptional scenario and
an operation associated with at least one task of the second task group; and
receiving results of performing the at least one task of the second task group and at least one task of the second exceptional task group based on:
the operation associated with the at least one task of the second task group; and
an operation associated with the at least one task of the second exceptional task group.

19. The method of claim 16, further comprising:
applying a third scenario to a second workflow engine of the control system to obtain a third task group based on the state of the robot being a third state different from the first state and the second state;
transmitting, to the robot via a first channel of the control system, at least one task of the third task group;
causing an operation associated with the at least one task of the third task group, the at least one task of the third task group being sent, by the control system, in the third state; and
receiving, via a second channel of the control system, the state of the robot and the state of the network.

20. The method of claim 19, further comprising:
determining whether the state of the robot is an exceptional state based on the state of the robot and the state of the network, wherein the state of the robot and the state of the network are received from the robot;
transmitting an operation stop command to the robot through the first channel based on the state of the robot being the exceptional state; and
applying a third exceptional scenario to the second workflow engine to obtain a third exceptional task group.
